(19) United States
(12) Patent Application Publication
(10) Pub. No.: US 2015/0378329 A1
(43) Pub. Date: Dec. 31, 2015

(54) METHOD FOR CONTROLLING ELECTRONIC DEVICE INTERFACE WITH BREATHING CHARACTERISTICS

(71) Applicant: BEIJING JINHER SOFTWARE CO., LTD., Beijing (CN)

(72) Inventor: Runfeng LUAN, Beijing (CN)

(21) Appl. No.: 14/337,245

(22) Filed: Jul. 22, 2014

(30) Foreign Application Priority Data
Jun. 25, 2014 (CN) 201410294873.8
Jul. 15, 2014 (CN) 201410334800.7

(51) Int. Cl. G05B 15/02

(52) U.S. Cl. CPC G05B 15/02

(57) ABSTRACT

The present invention provide a method for controlling an electronic device interface with breathing characteristics, comprising: detecting the breathing characteristics of a user who is operating an electronic device; in case the electronic device screen is displaying a first interface of a first group of interfaces for the first application, upon detecting that said breathing characteristics matches a first predefined breathing characteristics, replacing the first interface with a second interface of the first group of interfaces; upon detecting that said breathing characteristics matches a second predefined breathing characteristics, replacing the first interface with a third interface of the first group of interfaces. In the present invention, healthy breathing and operations of an electronic device are combined, so that the user can do breathing exercise during operating the electronic device. The dirty air in the body is discharged by breathing deeply.

### CROSS-REFERENCE TO RELATED APPLICATION

This application claims the priority benefit of Chinese patent application No. 201410294873.8, filed Jun. 25, 2014 and No. 201410334800.7, filed Jul. 15,2014. The entirety of the above-mentioned application is hereby incorporated by reference herein and made a part of specification.

### BACKGROUND OF THE INVENTION

1. Field of the Invention

The present invention relates to the field of controlling an electronic device interface, and particularly to a method for controlling an electronic device interface with breathing characteristics.

2. Background of the Invention

In the modern society, people increasingly depend on the electronic device, especially a handheld electronic device like a mobile phone, pad. Using the electronic device for a long time gradually decreases the user's activities. Besides, keeping the same posture for a long time has an adverse effect on the body health. Thus, it is urgent to develop a method which enables people to do physical exercise and operate the electronic device simultaneously. Yoga, which is popular in recent years, makes people pay increasingly attention to adjust breathing. Associating healthy breathing with operations of the electronic device will be favored by the user of electronic device. Besides, due to serious air pollution in recent years, especially due to the haze, people's breathing system has been damaged to a certain degree, while healthy breathing facilitates discharging the dirty air in the body and thus cleaning up the lung.

### BRIEF SUMMARY OF THE INVENTION

In order to solve the above problem, the present invention provides a method for controlling an electronic device interface with breathing characteristics, comprising:

detecting the breathing characteristics of a user who is operating an electronic device;

displaying a first application; and

in case the electronic device screen is displaying a first interface of a first group of interfaces for the first application,

upon detecting that said breathing characteristics matches a first predefined breathing characteristics, replacing the first interface with a second interface of the first group of interfaces, wherein the second interface is different from the first interface;

upon detecting that said breathing characteristics matches a second predefined breathing characteristics, replacing the first interface with a third interface of the first group of interfaces, wherein the third interface is different from the first interface and the second interface;

wherein the first and second predefined breathing characteristics are stored in the electronic device in advance.

Preferably, in the method for controlling an electronic device interface with breathing characteristics, said breathing characteristics is a breathing rhythm or an expiratory volume, wherein the expiratory volume indicates a volume V of gas exhaled in 10 seconds.

Preferably, the method for controlling an electronic device interface with breathing characteristics comprises: detecting continuously the breathing characteristics of the user who is operating the electronic device.

Preferably, the method for controlling an electronic device interface with breathing characteristics comprises: detecting at an interval the breathing characteristics of the user who is operating the electronic device, wherein said interval is a time value of 2-10 seconds.

Preferably, in the method for controlling an electronic device interface with breathing characteristics, the first and second predefined breathing characteristics are breathing rhythms, the first predefined breathing characteristics indicates a breathing duration of 20-30 seconds for each time, and the second predefined breathing characteristics indicates a breathing duration of 8-19 seconds for each time.

The common breathing duration for each time is 3-4 seconds. In the first predefined breathing characteristics and the second predefined breathing characteristics, the breathing duration for each time is longer than the common breathing duration. This indicates that the user breathes deeply, so that the residual gas in the lung and other metabolites can be discharged, more fresh air can be inhaled to supply oxygen needed for various organs, and the function of organs is thus increased or improved. Breathing deeply makes relevant muscles of chest and abdomen, as well as organs to exercise significantly. Thus, more oxygen can be inhaled, carbon dioxide can be discharged, and the blood circulation is enhanced. This is beneficial for removing fatigue and relaxing the mind.

Preferably, in the method for controlling an electronic device interface with breathing characteristics, the first and second predefined breathing characteristics are expiratory volume; the first predefined breathing characteristics indicates that the volume V of gas exhaled in 10 seconds lies in a range of 500 ml≦V<800 ml; and the second predefined breathing characteristics indicates that the volume V of gas exhaled in 10 seconds lies in a range of 800 ml≦V<1200 ml;

Exhaling a large amount of gas in a short time can improve the capacity of lung. A high capacity of lung can improve the strength of respiratory muscles, increase the elasticity of lung, and improve the respiratory mechanism.

Preferably, in the method for controlling an electronic device interface with breathing characteristics, the first application comprises a browser, a picture, music, and an incoming call.

Preferably, the method for controlling an electronic device interface with breathing characteristics further comprises:

displaying a second application; and

in case the second application is displaying a first interface of a second group of interfaces,

upon detecting that the expiratory volume matches a first predefined expiratory volume, replacing the first interface with a second interface of the second group of interfaces;

upon detecting that the expiratory volume matches a second predefined expiratory volume, replacing the first interface with a third interface of the second group of interfaces, wherein the third interface is different from the second interface;

upon detecting that the expiratory volume matches a third predefined expiratory volume, replacing the first interface with a fourth interface of the second group of interfaces, wherein the fourth interface is different from the second interface and the third interface;

upon detecting that the expiratory volume matches a fourth predefined expiratory volume, replacing the first interface with a fifth interface of the second group of interfaces, wherein the fifth predefined interface is different from the second interface, the third interface, and the fourth interface;

wherein,

the first, second, third, and fourth predefined expiratory volume applies to users of different ages, respectively;

the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

Preferably, in the method for controlling an electronic device interface with breathing characteristics,

the first predefined expiratory volume indicates that the volume V of gas exhaled in 10 seconds lies in a range of 500 ml≦V<800 ml;

the second predefined expiratory volume indicates that the volume V of gas exhaled in 10 seconds lies in a range of 800 ml≦V<1200 ml;

the third predefined expiratory volume indicates that the volume V of gas exhaled in 10 seconds lies in a range of 1200 ml≦V<1600 ml;

the fourth predefined expiratory volume indicates that the volume V of gas exhaled in 10 seconds lies in a range of V≧1600 ml.

Preferably, in the method for controlling an electronic device interface with breathing characteristics, the second application comprises themes, desktops, and fonts.

An electronic device with an interface controlled by breathing characteristics, comprise:

means for detecting the breathing characteristics of a user who is operating an electronic device;

means for displaying a first application; and

in case the electronic device screen is displaying a first interface of a first group of interfaces for the first application,

means for, upon detecting that said breathing characteristics matches a first predefined breathing characteristics, replacing the first interface with a second interface of the first group of interfaces, wherein the second interface is different from the first interface;

means for, upon detecting that said breathing characteristics matches a second predefined breathing characteristics, replacing the first interface with a third interface of the first group of interfaces, wherein the third interface is different from the first interface and the second interface;

wherein the first and second predefined breathing characteristics are stored in the electronic device in advance.

Preferably, in the electronic device with an interface controlled by breathing characteristics, said breathing characteristics is a breathing rhythm or an expiratory volume, wherein the expiratory volume indicates a volume V of gas exhaled in 10 seconds.

Preferably, in the electronic device with an interface controlled by breathing characteristics, the breathing characteristics of the user who is operating the electronic device is detected continuously.

Preferably, in the electronic device with an interface controlled by breathing characteristics, the breathing characteristics of the user who is operating the electronic device is detected at an interval, wherein said interval is a time value of 2-10 seconds.

Preferably, in the electronic device with an interface controlled by breathing characteristics, the first and second predefined breathing characteristics are breathing rhythms; the first predefined breathing characteristics indicates a breathing duration of 20-30 seconds for each time; and the second predefined breathing characteristics indicates a breathing duration of 8-19 seconds for each time.

Preferably, in the electronic device with an interface controlled by breathing characteristics, the first and second predefined breathing characteristics are expiratory volume; the first predefined breathing characteristics indicates that the volume V of gas exhaled in 10 seconds lies in a range of 500 ml≦V<800 ml; and the second predefined breathing characteristics indicates that the volume V of gas exhaled in 10 seconds lies in a range of 800 ml≦V<1200 ml.

Preferably, in the electronic device with an interface controlled by breathing characteristics, the first application comprises a browser, a picture, music, and an incoming call.

Preferably, the electronic device with an interface controlled by breathing characteristics further comprises:

means for displaying a second application; and

in case the second application is displaying a first interface of a second group of interfaces,

means for, upon detecting that the expiratory volume matches a first predefined expiratory volume, replacing the first interface with a second interface of the second group of interfaces;

means for, upon detecting that the expiratory volume matches a second predefined expiratory volume, replacing the first interface with a third interface of the second group of interfaces, wherein the third interface is different from the second interface;

means for, upon detecting that the expiratory volume matches a third predefined expiratory volume, replacing the first interface with a fourth interface of the second group of interfaces, wherein the fourth interface is different from the second interface and the third interface;

means for, upon detecting that the expiratory volume matches a fourth predefined expiratory volume, replacing the first interface with a fifth interface of the second group of interfaces, wherein the fifth predefined interface is different from the second interface, the third interface, and the fourth interface;

wherein,

the first, second, third, and fourth predefined expiratory volume applies to users of different ages, respectively;

the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

Preferably, in the electronic device with an interface controlled by breathing characteristics, the first predefined expiratory volume indicates that the volume V of gas exhaled in 10 seconds lies in a range of 500 ml≦V<800 ml; the second predefined expiratory volume indicates that the volume V of gas exhaled in 10 seconds lies in a range of 800 ml≦V<1200 ml; the third predefined expiratory volume indicates that the volume V of gas exhaled in 10 seconds lies in a range of 1200 ml≦V<1600 ml; and the fourth predefined expiratory volume indicates that the volume V of gas exhaled in 10 seconds lies in a range of V≧1600 ml.

Preferably, in the electronic device with an interface controlled by breathing characteristics, the second application comprises themes, desktops, and fonts.

The present invention provides a method for controlling an electronic device interface with breathing characteristics. Healthy breathing and operations of an electronic device are combined, so that the user can do breathing exercise during operating the electronic device. The dirty air in the body is discharged by breathing deeply, and the body is cleaned up. In addition, by changing different breathing rhythms and expiratory volumes, it is possible to switch the electronic device interface without affecting the normal use of the electronic device, making it interesting and scientific, and simultaneously to achieve the effect of keeping fit.

### DETAILED DESCRIPTION OF THE EMBODIMENTS

The present invention will be described in detail hereinafter by referring to its embodiments, so that the skilled in the art can implement the present invention in accordance with the present disclosure.

### First Embodiment

The present invention provides a method for controlling an electronic device interface with breathing characteristics, comprising:

detecting the breathing characteristics of a user who is operating an electronic device;

displaying a first application; and

in case the electronic device screen is displaying a first interface of a first group of interfaces for the first application,

upon detecting that said breathing characteristics matches a first predefined breathing characteristics, replacing the first interface with a second interface of the first group of interfaces, wherein the second interface is different from the first interface;

upon detecting that said breathing characteristics matches a second predefined breathing characteristics, replacing the first interface with a third interface of the first group of interfaces, wherein the third interface is different from the first interface and the second interface;

wherein the first and second predefined breathing characteristics are stored in the electronic device in advance.

In the method for controlling an electronic device interface with breathing characteristics, said breathing characteristics is a breathing rhythm or an expiratory volume, and the expiratory volume indicates a volume V of gas exhaled in 10 seconds.

The method for controlling an electronic device interface with breathing characteristics comprises: detecting at an interval the breathing characteristics of the user who is operating the electronic device, wherein said interval is a time value of 2-10 seconds.

In the method for controlling an electronic device interface with breathing characteristics, the first and second predefined breathing characteristics are expiratory volume; the first predefined breathing characteristics indicates that the volume V of gas exhaled in 10 seconds lies in a range of 500 ml≦V<800 ml; and the second predefined breathing characteristics indicates that the volume V of gas exhaled in 10 seconds lies in a range of 800 ml≦V<1200 ml.

In the method for controlling an electronic device interface with breathing characteristics, the first application comprises a browser, a picture, music, and an incoming call.

The method for controlling an electronic device interface with breathing characteristics further comprises:

displaying a second application; and

in case the second application is displaying a first interface of a second group of interfaces,

upon detecting that the expiratory volume matches a first predefined expiratory volume, replacing the first interface with a second interface of the second group of interfaces;

upon detecting that the expiratory volume matches a second predefined expiratory volume, replacing the first interface with a third interface of the second group of interfaces, wherein the third interface is different from the second interface;

upon detecting that the expiratory volume matches a third predefined expiratory volume, replacing the first interface with a fourth interface of the second group of interfaces, wherein the fourth interface is different from the second interface and the third interface;

upon detecting that the expiratory volume matches a fourth predefined expiratory volume, replacing the first interface with a fifth interface of the second group of interfaces, wherein the fifth predefined interface is different from the second interface, the third interface, and the fourth interface;

wherein,

the first, second, third, and fourth predefined expiratory volume applies to users of different ages, respectively;

the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

In the method for controlling an electronic device interface with breathing characteristics, the first predefined expiratory volume indicates that the volume V of gas exhaled in 10 seconds lies in a range of 500 ml≦V<800 ml; the second predefined expiratory volume indicates that the volume V of gas exhaled in 10 seconds lies in a range of 800 ml≦V<1200 ml; the third predefined expiratory volume indicates that the volume V of gas exhaled in 10 seconds lies in a range of 1200 ml≦V<1600 ml; and the fourth predefined expiratory volume indicates that the volume V of gas exhaled in 10 seconds lies in a range of V≧1600 ml.

In the method for controlling an electronic device interface with breathing characteristics, the second application comprises themes, desktops, and fonts.

An electronic device with an interface controlled by breathing characteristics, comprises:

means for detecting the breathing characteristics of a user who is operating an electronic device;

means for displaying a first application; and

in case the electronic device screen is displaying a first interface of a first group of interfaces for the first application,

means for, upon detecting that said breathing characteristics matches a first predefined breathing characteristics, replacing the first interface with a second interface of the first group of interfaces, wherein the second interface is different from the first interface;

means for, upon detecting that said breathing characteristics matches a second predefined breathing characteristics, replacing the first interface with a third interface of the first group of interfaces, wherein the third interface is different from the first interface and the second interface;

wherein the first and second predefined breathing characteristics are stored in the electronic device in advance.

In the electronic device with an interface controlled by breathing characteristics, said breathing characteristics is a breathing rhythm or an expiratory volume, and the expiratory volume indicates a volume V of gas exhaled in 10 seconds.

In the electronic device with an interface controlled by breathing characteristics, the breathing characteristics of the user who is operating the electronic device is detected at an interval, wherein said interval is a time value of 2-10 seconds.

In the electronic device with an interface controlled by breathing characteristics, the first and second predefined breathing characteristics are expiratory volume; the first predefined breathing characteristics indicates that the volume V of gas exhaled in 10 seconds lies in a range of 500 ml≦V<800 ml; and the second predefined breathing characteristics indicates that the volume V of gas exhaled in 10 seconds lies in a range of 800 ml≦V<1200 ml.

In the electronic device with an interface controlled by breathing characteristics, the first application comprises a browser, a picture, music, and an incoming call.

The electronic device with an interface controlled by breathing characteristics further comprises:

means for displaying a second application; and

in case the second application is displaying a first interface of a second group of interfaces,

means for, upon detecting that the expiratory volume matches a first predefined expiratory volume, replacing the first interface with a second interface of the second group of interfaces;

means for, upon detecting that the expiratory volume matches a second predefined expiratory volume, replacing the first interface with a third interface of the second group of interfaces, wherein the third interface is different from the second interface;

means for, upon detecting that the expiratory volume matches a third predefined expiratory volume, replacing the first interface with a fourth interface of the second group of interfaces, wherein the fourth interface is different from the second interface and the third interface;

means for, upon detecting that the expiratory volume matches a fourth predefined expiratory volume, replacing the first interface with a fifth interface of the second group of interfaces, wherein the fifth predefined interface is different from the second interface, the third interface, and the fourth interface;

wherein,

the first, second, third, and fourth predefined expiratory volume applies to users of different ages, respectively;

the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

In the electronic device with an interface controlled by breathing characteristics, the first predefined expiratory volume indicates that the volume V of gas exhaled in 10 seconds lies in a range of 500 ml≦V<800 ml; the second predefined expiratory volume indicates that the volume V of gas exhaled in 10 seconds lies in a range of 800 ml≦V<1200 ml; the third predefined expiratory volume indicates that the volume V of gas exhaled in 10 seconds lies in a range of 1200 ml≦V<1600 ml; and the fourth predefined expiratory volume indicates that the volume V of gas exhaled in 10 seconds lies in a range of V≧1600 ml.

In the electronic device with an interface controlled by breathing characteristics, the second application comprises themes, desktops, and fonts.

### Second Embodiment

The present invention provide a method for controlling an electronic device interface with breathing characteristics, comprising:

detecting the breathing characteristics of a user who is operating an electronic device;

displaying a first application; and

in case the electronic device screen is displaying a first interface of a first group of interfaces for the first application,

upon detecting that said breathing characteristics matches a first predefined breathing characteristics, replacing the first interface with a second interface of the first group of interfaces, wherein the second interface is different from the first interface;

upon detecting that said breathing characteristics matches a second predefined breathing characteristics, replacing the first interface with a third interface of the first group of interfaces, wherein the third interface is different from the first interface and the second interface;

wherein the first and second predefined breathing characteristics are stored in the electronic device in advance.

In the method for controlling an electronic device interface with breathing characteristics, said breathing characteristics is a breathing rhythm or an expiratory volume, and the expiratory volume indicates a volume V of gas exhaled in 10 seconds.

The method for controlling an electronic device interface with breathing characteristics comprises: detecting continuously the breathing characteristics of the user who is operating the electronic device.

In the method for controlling an electronic device interface with breathing characteristics, the first and second predefined breathing characteristics are breathing rhythms; the first predefined breathing characteristics indicates a breathing duration of 20-30 seconds for each time; and the second predefined breathing characteristics indicates a breathing duration of 8-19 seconds for each time.

In the method for controlling an electronic device interface with breathing characteristics, the first application comprises a browser, a picture, music, and an incoming call.

The method for controlling an electronic device interface with breathing characteristics further comprises:

displaying a second application; and

in case the second application is displaying a first interface of a second group of interfaces,

upon detecting that the expiratory volume matches a first predefined expiratory volume, replacing the first interface with a second interface of the second group of interfaces;

upon detecting that the expiratory volume matches a second predefined expiratory volume, replacing the first interface with a third interface of the second group of interfaces, wherein the third interface is different from the second interface;

upon detecting that the expiratory volume matches a third predefined expiratory volume, replacing the first interface with a fourth interface of the second group of interfaces, wherein the fourth interface is different from the second interface and the third interface;

upon detecting that the expiratory volume matches a fourth predefined expiratory volume, replacing the first interface with a fifth interface of the second group of interfaces, wherein the fifth predefined interface is different from the second interface, the third interface, and the fourth interface;

wherein,

the first, second, third, and fourth predefined expiratory volume applies to users of different ages, respectively;

the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

In the method for controlling an electronic device interface with breathing characteristics, the first predefined expiratory volume indicates that the volume V of gas exhaled in 10 seconds lies in a range of 500 ml≦V<800 ml; the second predefined expiratory volume indicates that the volume V of gas exhaled in 10 seconds lies in a range of 800 ml≦V<1200 ml; the third predefined expiratory volume indicates that the volume V of gas exhaled in 10 seconds lies in a range of 1200 ml≦V<1600 ml; and the fourth predefined expiratory volume indicates that the volume V of gas exhaled in 10 seconds lies in a range of V≧1600 ml.

In the method for controlling an electronic device interface with breathing characteristics, the second application comprises themes, desktops, and fonts.

An electronic device with an interface controlled by breathing characteristics comprises:

means for detecting the breathing characteristics of a user who is operating an electronic device;

means for displaying a first application; and

in case the electronic device screen is displaying a first interface of a first group of interfaces for the first application,

means for, upon detecting that said breathing characteristics matches a first predefined breathing characteristics, replacing the first interface with a second interface of the first group of interfaces, wherein the second interface is different from the first interface;

means for, upon detecting that said breathing characteristics matches a second predefined breathing characteristics, replacing the first interface with a third interface of the first group of interfaces, wherein the third interface is different from the first interface and the second interface;

wherein the first and second predefined breathing characteristics are stored in the electronic device in advance.

In the electronic device with an interface controlled by breathing characteristics, said breathing characteristics is a breathing rhythm or an expiratory volume, and the expiratory volume indicates a volume V of gas exhaled in 10 seconds.

In the electronic device with an interface controlled by breathing characteristics, the breathing characteristics of the user who is operating the electronic device is detected continuously.

In the electronic device with an interface controlled by breathing characteristics, the first and second predefined breathing characteristics are breathing rhythms; the first predefined breathing characteristics indicates a breathing duration of 20-30 seconds for each time; and the second predefined breathing characteristics indicates a breathing duration of 8-19 seconds for each time.

In the electronic device with an interface controlled by breathing characteristics, the first application comprises a browser, a picture, music, and an incoming call.

The electronic device with an interface controlled by breathing characteristics further comprises:

means for displaying a second application; and

in case the second application is displaying a first interface of a second group of interfaces,

means for, upon detecting that the expiratory volume matches a first predefined expiratory volume, replacing the first interface with a second interface of the second group of interfaces;

means for, upon detecting that the expiratory volume matches a second predefined expiratory volume, replacing the first interface with a third interface of the second group of interfaces, wherein the third interface is different from the second interface;

means for, upon detecting that the expiratory volume matches a third predefined expiratory volume, replacing the first interface with a fourth interface of the second group of interfaces, wherein the fourth interface is different from the second interface and the third interface;

means for, upon detecting that the expiratory volume matches a fourth predefined expiratory volume, replacing the first interface with a fifth interface of the second group of interfaces, wherein the fifth predefined interface is different from the second interface, the third interface, and the fourth interface;

wherein,

the first, second, third, and fourth predefined expiratory volume applies to users of different ages, respectively;

the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

In the electronic device with an interface controlled by breathing characteristics, the first predefined expiratory volume indicates that the volume V of gas exhaled in 10 seconds lies in a range of 500 ml≦V<800 ml; the second predefined expiratory volume indicates that the volume V of gas exhaled in 10 seconds lies in a range of 800 ml≦V<1200 ml; the third predefined expiratory volume indicates that the volume V of gas exhaled in 10 seconds lies in a range of 1200 ml≦V<1600 ml; and the fourth predefined expiratory volume indicates that the volume V of gas exhaled in 10 seconds lies in a range of V≧1600 ml.

In the electronic device with an interface controlled by breathing characteristics, the second application comprises themes, desktops, and fonts.

The present invention provides a method for controlling an electronic device interface with breathing characteristics. Healthy breathing and operations of an electronic device are combined, so that the user can do breathing exercise during operating the electronic device. The dirty air in the body is discharged by breathing deeply to clean up the body. In addition, by changing different breathing rhythms and expiratory volumes, it is possible to switch the electronic device interface without affecting the normal use of the electronic device, making it interesting and scientific, and simultaneously to achieve the effect of keeping fit.

Although the present invention has been described above with reference to specific embodiments, it should be understood that the limitations of the described embodiments are merely for illustrative purpose and by no means limiting. Instead, the scope of the invention is defined by the appended claims rather than by the description, and all variations that fall within the range of the claims are intended to be embraced therein. Thus, other embodiments than the specific ones described above are equally possible within the scope of these appended claims.

What is claimed is:

1. A method for controlling an electronic device interface with breathing characteristics, characterized by comprising:
detecting the breathing characteristics of a user who is operating an electronic device;
displaying a first application; and
in case the electronic device screen is displaying a first interface of a first group of interfaces for the first application,
upon detecting that said breathing characteristics matches a first predefined breathing characteristics, replacing the first interface with a second interface of the first group of interfaces, wherein the second interface is different from the first interface; and
upon detecting that said breathing characteristics matches a second predefined breathing characteristics, replacing the first interface with a third interface of the first group of interfaces, wherein the third interface is different from the first interface and the second interface,
wherein the first and second predefined breathing characteristics are stored in the electronic device in advance.

2. The method of claim 1, characterized in that,
the breathing characteristics is a breathing rhythm or an expiratory volume, the expiratory volume indicating a volume V of gas exhaled in 10 seconds.

3. The method of claim 2, characterized in that,
detecting continuously the breathing characteristics of the user who is operating the electronic device.

4. The method of claim 2, characterized in that,
detecting at an interval the breathing characteristics of the user who is operating the electronic device, wherein said interval is a time value of 2-10 seconds.

5. The method of claim 2, characterized in that,
the first and second predefined breathing characteristics are breathing rhythms;
the first predefined breathing characteristics indicates a breathing duration of 20-30 seconds for each time; and
the second predefined breathing characteristics indicates a breathing duration of 8-19 seconds for each time.

6. The method of claim 2, characterized in that,
the first and second predefined breathing characteristics are expiratory volume;
the first predefined breathing characteristics indicates that the volume V of gas exhaled in 10 seconds lies in a range of 500 ml≦V<800 ml; and
the second predefined breathing characteristics indicates that the volume V of gas exhaled in 10 seconds lies in a range of 800 ml≦V<1200 ml.

7. The method of claim 1, characterized in that,
the first application comprises a browser, a picture, music, and an incoming call.

8. The method of claim 2, characterized by further comprising:
displaying a second application; and
in case the second application is displaying a first interface of a second group of interfaces,
upon detecting that the expiratory volume matches a first predefined expiratory volume, replacing the first interface with a second interface of the second group of interfaces;
upon detecting that the expiratory volume matches a second predefined expiratory volume, replacing the first interface with a third interface of the second group of interfaces, wherein the third interface is different from the second interface;
upon detecting that the expiratory volume matches a third predefined expiratory volume, replacing the first interface with a fourth interface of the second group of interfaces, wherein the fourth interface is different from the second interface and the third interface;
upon detecting that the expiratory volume matches a fourth predefined expiratory volume, replacing the first interface with a fifth interface of the second group of interfaces, wherein the fifth predefined interface is different from the second interface, the third interface, and the fourth interface;
wherein,
the first, second, third, and fourth predefined expiratory volume applies to users of different ages, respectively;
the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

9. The method of claim 8, characterized in that,
the first predefined expiratory volume indicates that the volume V of gas exhaled in 10 seconds lies in a range of 500 ml≦V<800 ml;
the second predefined expiratory volume indicates that the volume V of gas exhaled in 10 seconds lies in a range of 800 ml≦V<1200 ml;
the third predefined expiratory volume indicates that the volume V of gas exhaled in 10 seconds lies in a range of 1200 ml≦V<1600 ml;
the fourth predefined expiratory volume indicates that the volume V of gas exhaled in 10 seconds lies in a range of V≧1600 ml.

10. The method of claim 8, characterized in that,
the second application comprises themes, desktops, and fonts.

11. An electronic device with an interface controlled by breathing characteristics, characterized by comprising:
means for detecting the breathing characteristics of a user who is operating an electronic device;
means for displaying a first application; and
in case the electronic device screen is displaying a first interface of a first group of interfaces for the first application,
means for, upon detecting that said breathing characteristics matches a first predefined breathing characteristics, replacing the first interface with a second interface of the first group of interfaces, wherein the second interface is different from the first interface;
means for, upon detecting that said breathing characteristics matches a second predefined breathing characteristics, replacing the first interface with a third interface of the first group of interfaces, wherein the third interface is different from the first interface and the second interface;
wherein the first and second predefined breathing characteristics are stored in the electronic device in advance.

12. The electronic device of claim 11, characterized in that,
the breathing characteristics is a breathing rhythm or an expiratory volume, the expiratory volume indicating a volume V of gas exhaled in 10 seconds.

13. The electronic device of claim 12, characterized in that,
the breathing characteristics of the user who is operating the electronic device is detected continuously.

14. The electronic device of claim 12, characterized in that,
the breathing characteristics of the user who is operating the electronic device is detected at an interval, wherein said interval is a time value of 2-10 seconds.

15. The electronic device of claim 12, characterized in that,
the first and second predefined breathing characteristics are breathing rhythms;
the first predefined breathing characteristics indicates a breathing duration of 20-30 seconds for each time;
the second predefined breathing characteristics indicates a breathing duration of 8-19 seconds for each time.

16. The electronic device of claim 12, characterized in that,
the first and second predefined breathing characteristics are expiratory volume;
the first predefined breathing characteristics indicates that the volume V of gas exhaled in 10 seconds lies in a range of 500 ml≦V<800 ml; and
the second predefined breathing characteristics indicates that the volume V of gas exhaled in 10 seconds lies in a range of 800 ml≦V<1200 ml.

17. The electronic device of claim 11, characterized in that,
the first application comprises a browser, a picture, music, and an incoming call.

18. The electronic device of claim 12, characterized by further comprising:
means for displaying a second application; and
in case the second application is displaying a first interface of a second group of interfaces,
means for, upon detecting that the expiratory volume matches a first predefined expiratory volume, replacing the first interface with a second interface of the second group of interfaces;
means for, upon detecting that the expiratory volume matches a second predefined expiratory volume, replacing the first interface with a third interface of the second group of interfaces, wherein the third interface is different from the second interface;
means for, upon detecting that the expiratory volume matches a third predefined expiratory volume, replacing the first interface with a fourth interface of the second group of interfaces, wherein the fourth interface is different from the second interface and the third interface;
means for, upon detecting that the expiratory volume matches a fourth predefined expiratory volume, replacing the first interface with a fifth interface of the second group of interfaces, wherein the fifth predefined interface is different from the second interface, the third interface, and the fourth interface;
wherein,
the first, second, third, and fourth predefined expiratory volume applies to users of different ages, respectively;
the first predefined expiratory volume and the second interface, the second predefined expiratory volume and the third interface, the third predefined expiratory volume and the fourth interface, and the fourth predefined expiratory volume and the fifth interface are associated and stored in the electronic device in advance, respectively.

19. The electronic device of claim 18, characterized in that,
the first predefined expiratory volume indicates that the volume V of gas exhaled in 10 seconds lies in a range of 500 ml≦V<800 ml;
the second predefined expiratory volume indicates that the volume V of gas exhaled in 10 seconds lies in a range of 800 ml≦V<1200 ml;
the third predefined expiratory volume indicates that the volume V of gas exhaled in 10 seconds lies in a range of 1200 ml≦V<1600 ml; and
the fourth predefined expiratory volume indicates that the volume V of gas exhaled in 10 seconds lies in a range of V≧1600 ml.

20. The electronic device of claim 11, characterized in that,
the second application comprises themes, desktops, and fonts.
